(19) United States
(12) Patent Application Publication
(10) Pub. No.: US 2007/0022085 A1
(43) Pub. Date: Jan. 25, 2007

(54) Techniques for unsupervised web content discovery and automated query generation for crawling the hidden web

(76) Inventor: Parashuram Kulkarni, Bangalore (IN)

Correspondence Address: HICKMAN PALERMO TRUONG & BECKER, LLP, 2055 GATEWAY PLACE, SUITE 550, SAN JOSE, CA, 95110, US

(21) Appl. No.: 11/224,887

(22) Filed: Sep. 12, 2005

(30) Foreign Application Priority Data
Jul. 22, 2005 (IN) 648/KOLNP/05

(51) Int. Cl. G06F 17/30

(52) U.S. Cl. 707/1

(57) ABSTRACT

Unsupervised crawling of the hidden Web utilizes a query engine, coupled to a crawler system, that automatically and intelligently inserts keywords into text input controls in Web page forms so that the filled form can be submitted to a server to retrieve dynamically generated Web content for indexing. The keywords used to fill form controls are based on the content of corresponding Web pages, which is automatically discovered to generate a set of keywords for filling the controls. The set of keywords can be expanded to include related keywords from other Web pages and Web sites and, therefore, to provide more effective coverage for crawling the Web content. The expanded set of keywords can be continuously expanded by recursively performing similarity analyses based on results from crawling the same and other Web sites.

### CROSS-REFERENCE TO RELATED APPLICATION

This application is related to and claims the benefit of priority from Indian Patent Application No. 648/KOLNP/05 filed in India on Jul. 22, 2005, entitled “Techniques for Unsupervised Web Content Discovery and Automated Query Generation for Crawling the Hidden Web”; the entire content of which is incorporated by this reference for all purposes as if fully disclosed herein.

### FIELD OF THE INVENTION

The present invention relates to computer networks and, more particularly, to techniques for automated discovery of World Wide Web content and automated query generation based on the content, for crawling dynamically generated Web content, also referred to as the “hidden Web.”

### BACKGROUND OF THE INVENTION

World Wide Web-General

The Internet is a worldwide system of computer networks and is a public, self-sustaining facility that is accessible to tens of millions of people worldwide. The most widely used part of the Internet is the World Wide Web, often abbreviated “WWW” or simply referred to as just “the Web”. The Web is an Internet service that organizes information through the use of hypermedia. The HyperText Markup Language (“HTML”) is typically used to specify the contents and format of a hypermedia document (e.g., a Web page).

In this context, an HTML file is a file that contains the source code for a particular Web page. A Web page is the image or collection of images that is displayed to a user when a particular HTML file is rendered by a browser application program. Unless specifically stated, an electronic or Web document may refer to either the source code for a particular Web page or the Web page itself. Each page can contain embedded references to images, audio, video or other Web documents. The most common type of reference used to identify and locate resources on the Internet is the Uniform Resource Locator, or URL. In the context of the Web, a user, using a Web browser, browses for information by following references that are embedded in each of the documents. The HyperText Transfer Protocol (“HTTP”) is the protocol used to access a Web document and the references that are based on HTTP are referred to as hyperlinks (formerly, “hypertext links”).

Static Web content generally refers to Web content that is fixed and not capable of action or change. A Web site that is static can only supply information that is written into the HTML source code and this information will not change unless the change is written into the source code. When a Web browser requests the specific static Web page, a server returns the page to the browser and the user only gets whatever information is contained in the HTML code. In contrast, a dynamic Web page contains dynamically-generated content that is returned by a server based on a user's request, such as information that is stored in a database associated with the server. The user can request that information be retrieved from a database based on user input parameters.

The most common mechanisms for providing input for a dynamic Web page in order to retrieve dynamic Web content are HTML forms and Java Script links. HTML forms are described in Section 17 (entitled “Forms”) of the W3C Recommendation entitled “HTML 4.01 Specification”, available from the W3C® organization; the content of which is incorporated by this reference in its entirety for all purposes as if fully disclosed herein.

Search Engines

Through the use of the Web, individuals have access to millions of pages of information. However a significant drawback with using the Web is that because there is so little organization to the Web, at times it can be extremely difficult for users to locate the particular pages that contain the information that is of interest to them. To address this problem, a mechanism known as a “search engine” has been developed to index a large number of Web pages and to provide an interface that can be used to search the indexed information by entering certain words or phases to be queried. These search terms are often referred to as “keywords”.

Indexes used by search engines are conceptually similar to the normal indexes that are typically found at the end of a book, in that both kinds of indexes comprise an ordered list of information accompanied with the location of the information. An “index word set” of a document is the set of words that are mapped to the document, in an index. For example, an index word set of a Web page is the set of words that are mapped to the Web page, in an index. For documents that are not indexed, the index word set is empty.

Although there are many popular Internet search engines, they are generally constructed using the same three common parts. First, each search engine has at least one, but typically more, “web crawler” (also referred to as “crawler”, “spider”, “robot”) that “crawls” across the Internet in a methodical and automated manner to locate Web documents around the world. Upon locating a document, the crawler stores the document's URL, and follows any hyperlinks associated with the document to locate other Web documents. Second, each search engine contains an indexing mechanism that indexes certain information about the documents that were located by the crawler. In general, index information is generated based on the contents of the HTML file associated with the document. The indexing mechanism stores the index information in large databases that can typically hold an enormous amount of information. Third, each search engine provides a search tool that allows users, through a user interface, to search the databases in order to locate specific documents, and their location on the Web (e.g., a URL), that contain information that is of interest to them.

The search engine interface allows users to specify their search criteria (e.g., keywords) and, after performing a search, an interface for displaying the search results. Typically, the search engine orders the search results prior to presenting the search results interface to the user. The order usually takes the form of a “ranking”, where the document with the highest ranking is the document considered most likely to satisfy the interest reflected in the search criteria specified by the user. Once the matching documents have been determined, and the display order of those documents has been determined, the search engine sends to the user that issued the search a “search results page” that presents information about the matching documents in the selected display order.

The “Hidden Web”

There are many Web crawlers that crawl and store content from the Web. The Web is becoming more dynamic by the day, and a larger share of the content is only accessible from behind HTML forms. There is no available technique for a crawler to get past HTML forms, which are meant primarily for real users, in order to access the dynamic Web content accessible via the HTML forms. Consequently, a basic crawler gets only the static content of the Web, but fails to crawl dynamic content, also referred to as the “hidden Web”, “deep Web” and the “invisible Web”.

Traditional Web crawlers retrieve content only from a portion of the Web, called the Publicly Indexable Web (PIW). This refers to the set of Web pages reachable exclusively by following hypertext links, ignoring search forms and pages that require authorization or registration. However, a significant fraction of Web content lies outside the PIW, which typical search engine crawlers simply cannot reach. Pages in the hidden Web are dynamically generated from databases and other sources hidden from the user and available only in response to queries submitted via the search forms. These pages are not literally hidden or invisible, but appear invisible to traditional search engine crawlers since they do not have a static URL and can be found only by some type of direct query from the search forms. These portions of the Web are “hidden” only in the sense that none of the traditional crawlers are able to index those pages. Most commonly, however, data in the hidden Web is stored in a database and is accessible by issuing queries guided by HTML forms.

Hidden Web content is very relevant to every information need and market. It has been suggested that at least one-half of the hidden Web information is found in topic specific databases. At least 95% of hidden Web is publicly accessible information, with no fees or subscriptions to pay. Sixty of the largest hidden Web sites together contain about 750 terabytes (1 terabyte=1 trillion bytes) of information. These sixty sites exceed the size of the surface Web by forty times. Research in this field has suggested that the size of the hidden Web is many times greater, both in quantity (estimated at 500 times) and quality than the PIW. Regardless of the actual relative size, it is clear that an enormous amount of data exists outside the so-called publicly indexable Web. Users want and need better access to this information.

Based on the foregoing, there is a need for improved techniques for automated crawling of dynamically generated Web content from databases.

Any approaches that may be described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram that illustrates a software system architecture, according to which an embodiment of the invention may be implemented;

FIG. 2 is a flow diagram that illustrates a process for automatically classifying a form, according to an embodiment of the invention;

FIG. 3 is a flow diagram that illustrates a process for automatically filling a Web page form text input control using unsupervised content discovery, according to an embodiment of the invention;

FIG. 4 is a flow diagram that illustrates a process for automatically determining the coverage of a Web site as a result of form filling, according to an embodiment of the invention; and

FIG. 5 is a block diagram that illustrates a computer system upon which an embodiment of the invention may be implemented.

### DETAILED DESCRIPTION OF EMBODIMENTS OF THE INVENTION

Techniques are described for automated Web page content discovery and automated query generation based thereon. In particular, techniques are described for automatically and intelligently filling controls in Web forms (e.g., HTML FORMS), based on the content of the associated Web site and possibly other Web sites, for crawling the hidden Web.

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

### Functional Overview of Embodiments

Some Web page forms include one or more fields that allow entry of text in the form of search keywords. For example, some forms include “text input” type of form controls. Use of keywords limits the domain of the particular search. An unsupervised technique for crawling the hidden Web utilizes a query engine, coupled to a crawler system, that automatically and intelligently inserts keywords into form controls, such as text boxes, in Web page forms so that the filled form can be automatically submitted to a server to query a database to retrieve dynamically generated Web content. The “interesting” keywords that are used to fill form controls for a given Web page are based on the content of Web pages associated with a Web site with which the given Web page is associated, where the content is automatically discovered. For example, the number of times terms occur in the content of a Web page can be used to determine which terms are significant enough to include in the set of keywords for filling text input controls for Web pages associated with that Web site.

The set of keywords for filling form controls can be expanded to include related keywords from other Web sites (e.g., via a “similarity analysis”) and, therefore, to provide more effective coverage for crawling the Web content. For example, if a particular term (e.g., “automobile”) occurs many times in a first Web page and is identified as an interesting keyword, and other terms (e.g., “chassis” and “engine”) consistently occur on other Web pages associated with other Web sites along with this keyword “automobile”, then the terms “automobile”, “chassis”, and “engine” are all considered closely related since these terms keep occurring together. Therefore, “chassis” and “engine” can be included in an expanded set of keywords used for crawling the first Web page. Furthermore, the expanded set of keywords can be continuously expanded by recursively performing the similarity analysis based on results from crawling the same and other Web sites. That is, a knowledge base of terms and their frequency of occurrence is constantly updated based on site crawls. Crawling of a Web site can be terminated in response to determining that a relatively large portion of the links being encountered in crawl results have already been encountered, i.e., that sufficient coverage of the site has been obtained.

System Architecture Example

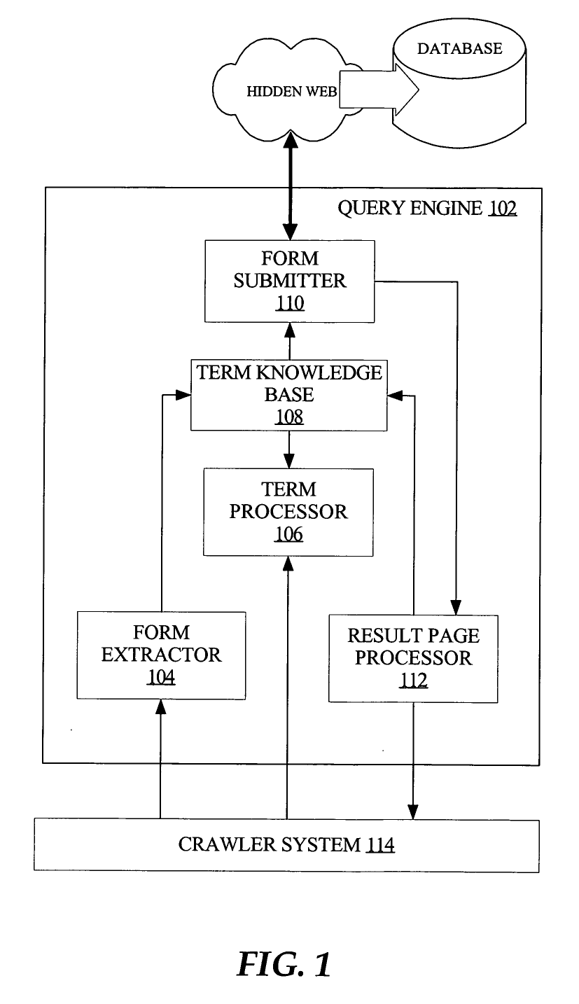

FIG. 1 is a block diagram that illustrates a software system architecture, according to which an embodiment of the invention may be implemented. FIG. 1 illustrates a query engine 102 coupled to a conventional Web crawler system 114. The query engine may comprise the following, the functionality of each of which is described in greater detail herein: a form extractor 104, a term processor 106, a term knowledge base 108, a form submitter 110, and a result page processor 112. The software system architecture in which embodiments of the invention are implemented may vary. FIG. 1 is one example of an architecture in which a plug-in query engine 102 is integrated with a conventional Web crawler system 114, for performing techniques described herein.

The query engine 102 is generally capable of automatically detecting HTML forms in Web pages, analyzing and filtering the forms using a decision tree, automatically discovering the content of the Web pages, and performing automated query generation (i.e., automated form control filling) and form submission. Further, query engine 102 is also capable of optionally combining user configurations with automation in order to more effectively crawl the hidden web while administering human-based policies. The functionality provided by query engine 102 can be applied to any Web domain, i.e., the functionality is not content-specific and no preexisting knowledge of the domain is needed. Furthermore, use of the query engine 102 to crawl hidden Web content does not require training data to be utilized in order to seed the crawl.

The general interactions between components of query engine 102 are as follows, with greater detail provided hereafter.

Form extractor 104 is capable of extracting forms from pages (e.g., HTML forms from Web pages), such as from Web pages visited and stored by a Web crawler system 114. Form extractor 104 can analyze and classify extracted forms as to whether or not each form is used to query a database (i.e., query the hidden Web) and the type of automated or semi-automated form filling process that can or should be used query the database. A possible approach to extracting page forms in furtherance of crawling dynamic Web content is described in U.S. patent application Ser. No. 11/064,278 filed on Feb. 22, 2005, entitled “Techniques for Crawling Dynamic Web Content”; the content of which is incorporated by this reference in its entirety for all purposes as if fully disclosed herein. Term extractor 104 can store its results in term knowledge base 108, for guidance to and use by form submitter 110 in automated submission of such extracted forms.

Term processor 106 is capable of analyzing the content of pages, such as pages visited and stored by a crawler system 114. Term processor 106 can perform some analysis and processing of terms/words contained in such pages, to determine a set of keywords based on the content of a page, for use in filling a control contained in a form from the page. As described hereafter, term processor 106 can generate a set of keywords for use in filling a given page's form controls based on the content of the given page and other pages associated with the same Web site as the given page. The set of keywords can be expanded to include related, or “similar”, terms from other pages and sites. Terms from other pages and sites are fed into a term knowledge base 108 from a result page processor 112, from which term processor 106 can retrieve and analyze the similarity that such terms may have with terms found in the given page.

In one embodiment, term knowledge base 108 is a database storing (a) information about forms extracted by form extractor 104 from pages visited by crawler system 114. Further, in one embodiment, term knowledge base 108 is a database further storing (b) a set of keywords for use in filling a form's control(s), by form submitter 110, where the set of keywords is derived by term processor 106 based on the complete content of pages (i.e., not just the information within the <form> tags) visited by crawler system 114. Still further, in one embodiment, term knowledge base 108 is a database further storing (c) related or similar keywords for use in filling a form's control(s), by form submitter 110, where the related keywords are derived by term processor 106 and/or result page processor 112 based on the content of other sites visited by crawler system 114.

Form submitter 110 is capable of automatically filling controls in Web page forms, based on information from term knowledge base 108, and submitting such filled forms to the appropriate server in order to retrieve hidden Web content from one or more associated databases or data repositories. The results from submission of such filled forms can be routed through result page processor 112 for analysis and processing as described in reference to determining an expanded set of related keywords. A possible approach to a form submitter 110 is described in U.S. patent application Ser. No. 11/064,278.

As mentioned, the query engine 102 architecture used to implement embodiments described herein may vary from implementation to implementation. For example, form submitter 110 could be implemented as part of crawler system 114, or query engine 102 could utilize similar form submission functionality built into crawler system 114.

Result page processor 112 is capable of analyzing and processing pages retrieved via form submitter 110 and/or crawler system 114. As mentioned, terms from various pages and sites are fed into a term knowledge base 108 from result page processor 112, from which term processor 106 can retrieve and analyze the relation that such terms may have with terms found in a given page. Result page processor 112 can also send information, such as links found in pages (e.g., pages without forms) retrieved through submission of filled forms by form submitter 110, to crawler system 114 for further conventional crawling.

Automatic Form Filling With Selection Options

As mentioned, when crawling the Web, a Web crawler follows hyperlinks (referred to hereafter simply as “links”) from Web page to Web page in order to index the content of each page. As part of the crawling process, crawlers typically parse the HTML document underlying each page, and build a DOM (Document Object Model) or other parse tree that represents the objects in the page. A DOM defines what attributes are associated with each object, and how the objects and attributes can be manipulated.

Generally, query engine 102 and/or a modified crawler system 114 is capable of detecting Web pages that contain a form that requires insertion of information to request content from a backend database. For example, such a Web page contains an HTML form through which information is submitted to a backend database in order to request content from the database. In the domain of job service Web pages, for example, the form may provide for submission of information to identify the type of jobs (e.g., engineering, legal, human resources, accounting, etc.) that a user is interested in viewing, and the location of such jobs (e.g., city, state, country).

In one embodiment, the presence of a form in a Web page is detected by analyzing a DOM (document object model) corresponding to the Web page. For example, the crawler detects a <FORM> tag in the HTML code as represented in the DOM. The term “form” is used hereafter in reference to any type of information submission mechanism contained within code for a Web page, for facilitating submission of requests to a server for dynamic Web content, typically generated from information stored in a database. An HTML form is one example of an information submission mechanism that is currently commonly used. However, embodiments of the invention are not limited to use in the context of HTML and HTML forms. Hence, the broad techniques described herein for crawling dynamically generated network content can be readily adapted by one skilled in the art to work in the context of other languages in which pages are coded, such as variations of HTML, XML, and the like, and to work in the context of other electronic form mechanisms other than those specified by the <FORM> tag, including such mechanisms not yet known or developed.

Some Web page forms can be completed and submitted, for query and retrieval of dynamically generated content, based on selection options provided in the form itself. For example, forms with controls such as radio buttons, checkboxes and selection lists can be iteratively submitted based on combinations of the selection options provided in the form. Possible approaches to crawling dynamic Web content are described in U.S. patent application Ser. No. 11/064,278. However, this reference does not exhaustively address one aspect of crawling dynamic Web content, which is the automated and intelligent filling and submission of form controls, such as a “text input” type of control (e.g., INPUT and/or TEXT AREA types of text input controls), that are not associated with corresponding selection options. Further, in order to fill text input type controls, it is necessary for the system to intelligently discover the topic/content of the Web site similar to how a human would know to use terms like “automobiles”, “cars”, etc. when searching an automobile site. The system described herein has the capability to perform such a content discovery operation.

Automatic Determination of Page Content

To enable access to dynamically generated Web content, crawler systems need to be able to see beyond the wall of Web forms. The crawlers need to identify, extract and fill these forms with relevant inputs to access Web pages “hidden” beyond the forms. Thus, automated extraction of data behind form interfaces is desirable when automated agents like crawlers are used to search for desired information. However, it is not practical to randomly fill Web forms. Further, even humans cannot predetermine the content of a web site which could possibly be encountered during a Web crawl. Therefore, a technique for automatically discovering the content of a Web site facilitates a practical and efficient crawl of the hidden Web.

There are scenarios in which the forms are not pure search forms with a single search text box and a group of other controls such as list boxes, but may require multiple and/or complex inputs, such as author, section, etc. In such scenarios, complete automation may not be effective or practical. Additionally, there are also forms, such as username-password forms, which require authentication. Thus, the type of form should be classified and complete automation used only where appropriate. In classifying a Web form (e.g., HTML forms) as a search interface or a non-search interface, the form itself is analyzed to classify the form based on its content.

In response to detecting a form in a Web page, form extractor 104 is invoked. The page is parsed, such as by creating a parse tree (e.g., a DOM) for the given source page, and usefull information is extracted from the form description. For example, an HTML form is indicated by the presence of start and end tags, <form> and </form> respectively. HTML forms are described in Section 17 (entitled “Forms”) of the W3C Recommendation entitled “HTML 4.01 Specification”, available from the W3C® organization; the content of which is incorporated by this reference in its entirety for all purposes as if fully disclosed herein.

If a form is present, the form portion is extracted from the parse tree, such as by form extractor 104. In one embodiment, for the purposes of experimentation and repetitive automated processing, the parse tree is persistently stored in a readily readable form. Information of particular interest includes the source URL of the page, the action URL to which the form will be submitted, the number of fields, and details for each field. These details include field names, field types and default values (domain information including, e.g., the available and default selected values for a selection list).

Form Classifying And Filtering

As mentioned, Web page forms can be classified as a search interface or a non-search interface, in order to determine what type of form filling process should be applied to the forms. In one embodiment, a decision process is applied to each extracted candidate form to determine whether or not the form is eligible for querying. The form may be further classified, based on the content of the form, as to whether or not the form is eligible for automated querying.

In one embodiment, the text input controls in the form are classified into one of the following classifications regarding the manner in which the control should be filled: (1) automated form filling using Web content discovery, through which the system can learn about the web page and automatically issue queries based thereon; (2) default value filling, in which the system utilizes any option selected values for the controls, as present in the page code (i.e., <option selected value=″″>all categories</option>), to fill the form; or (3) filling using a keyword configuration, through which the system utilizes a predetermined user (i.e., crawl administrator) keyword configuration to fill the form, when available. Such form classification may be performed, for example, by form extractor 104.

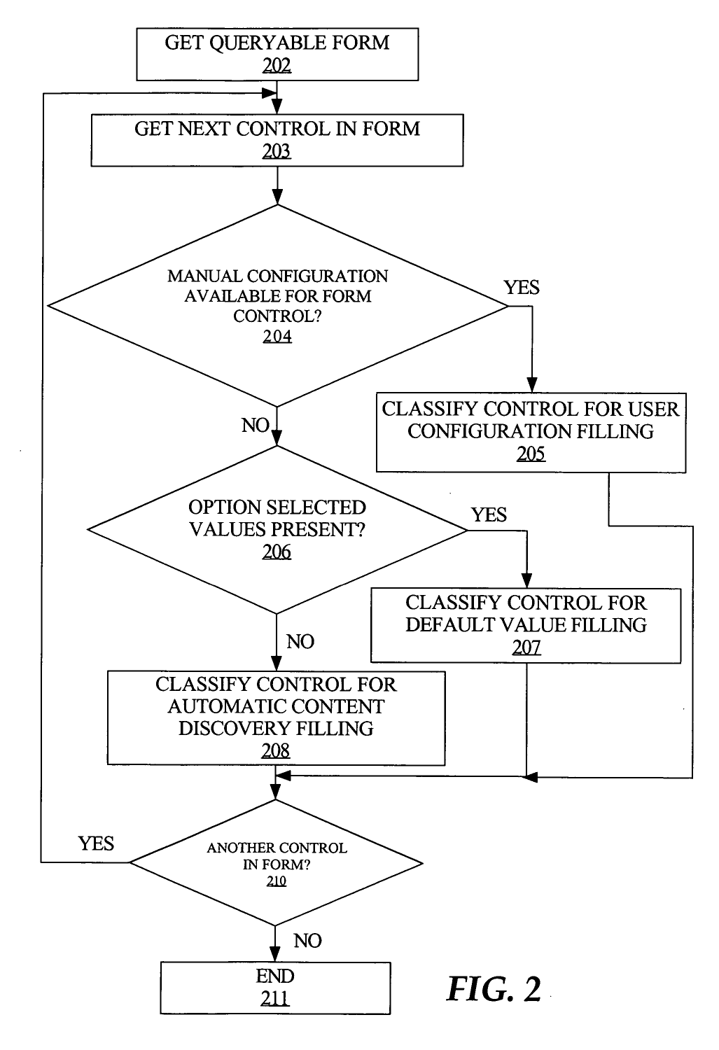

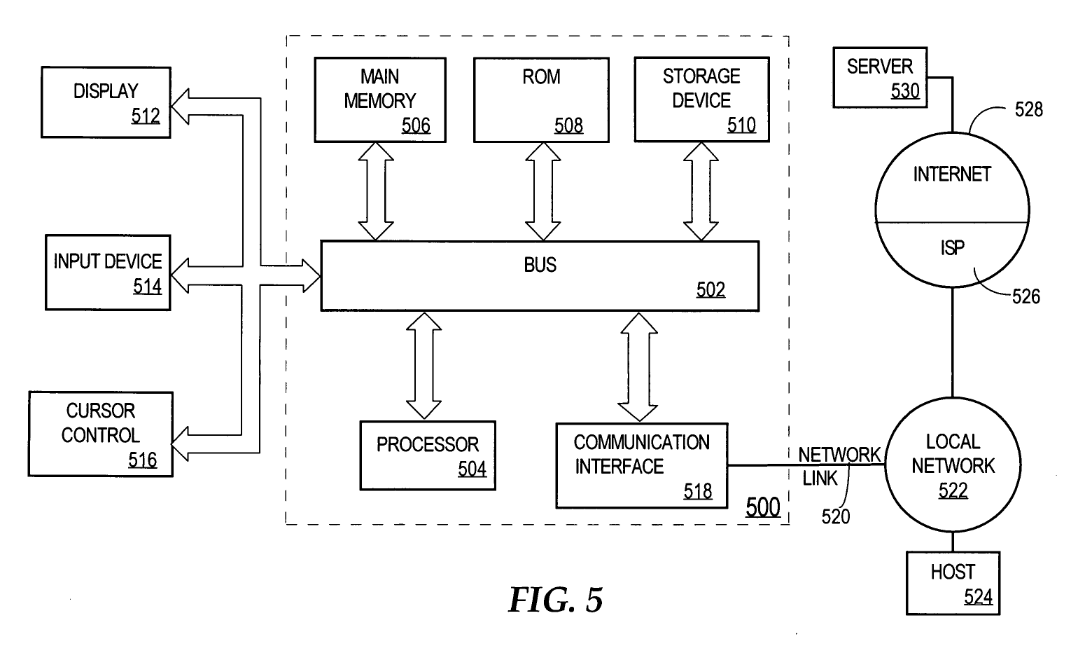

FIG. 2 is a flow diagram that illustrates a process for automatically classifying a form, according to an embodiment of the invention. The process of FIG. 2 determines how best to fill a form, in the context of crawling the hidden Web. For example, in response to encountering a page form, the process of FIG. 2 may be automatically performed by query engine 102 (FIG. 1) as part of a crawl of the Web content hidden behind the form. In one embodiment, the process illustrated in FIG. 2 is implemented for automated performance by a conventional computing system, such as computer system 500 of FIG. 5. Further, in one embodiment, the process illustrated in FIG. 2 is implemented for automated performance within a software system architecture, such as that illustrated in FIG. 1. Thus, the process illustrated in FIG. 2 may be performed by, for example, form submitter 110 (FIG. 1) or a similarly functioning component.

At block 202, a form, which can be used to query dynamically generated content, is retrieved. For example, form submitter 110 (FIG. 1) retrieves from term knowledge base 108 (FIG. 1) storage, or from some other crawler-related storage, a form extracted from a page by form extractor 104 (FIG. 1). For each control in the form, processing begins at block 203, at which information about the control is retrieved, such as from term knowledge base 108 storage or from some other crawler-related storage.

At decision block 204, it is determined whether a manually generated keyword configuration is available for filling in a form being processed. Some Web sites may be best crawled with some manual feeding. For example, a crawler administrator may construct one or more domain-specific sets of keywords, i.e., keyword configuration files that contain sets of keywords to feed into a crawler system 114 (FIG. 1) that is augmented for automatic form filling, for particular form controls, forms, or Web sites. If a keyword configuration exists for a form control, a form, or a site, then the user-based configuration is given precedence over other automated form filling options, such as form filling based on the associated content. Hence, if an applicable keyword configuration exists, then at block 205 the form control is classified for automatic filling using the values (e.g., keywords) from the pre-existing keyword configuration file. If there is no pre-existing applicable keyword configuration file for the current form control, then process control moves to decision block 206.

At decision block 206, it is determined whether the form being processed contains “option selected values.” With HTML, <OPTION . . . > is used along with <SELECT . . . > to create select lists. <OPTION . . . > indicates the start of a new option in the list. <OPTION . . . > can be used without any attributes, but usually a VALUE attribute is used, which indicates what is sent to the server. Use of SELECTED in association with the <OPTION> tag indicates that the option should be selected by default. The hidden Web content behind page forms that include default option selected values is often sufficiently crawled by simply using the default values provided by the option selected values. For example, the form could be submitted without filling any text input controls and, if successful in returning a sufficient amount of content, then there may be no need to fill keywords into the text input control. Hence, if the form contains option selected values, then at block 207 the form control is classified for automatic filling using default option selected values from within the page form.

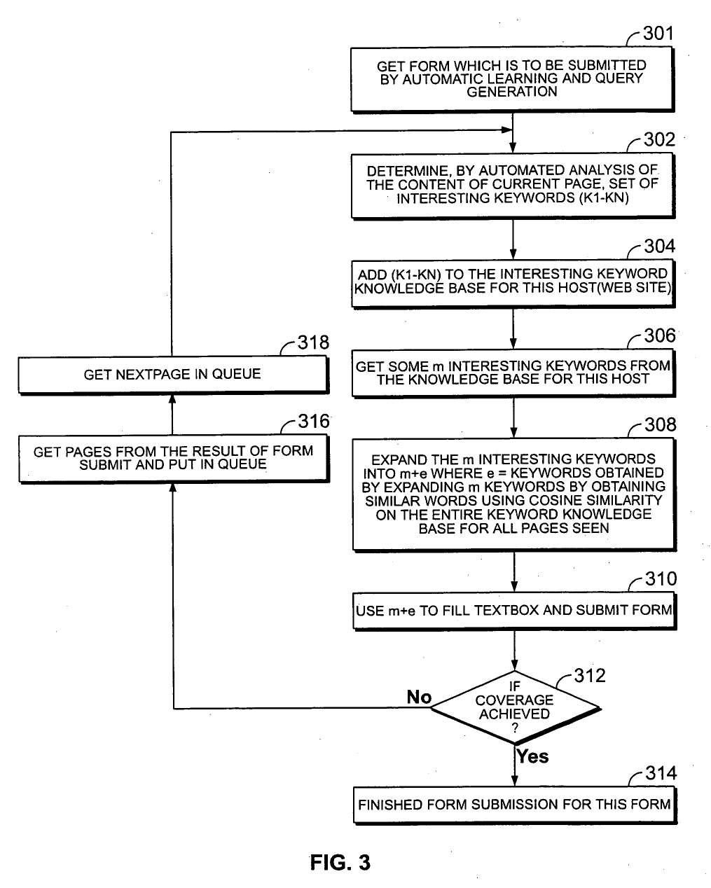

For forms for which no applicable keyword configuration is available at block 204, and for which no option selected values are present at block 206, control passes to block 208, at which the text input control is classified for automatic filling using automatically determined keyword sets based at least in part on automated discovery of the associated Web page content, as in the embodiment illustrated in FIG. 3.

At decision block 209, it is determined whether another form control is present in the form. If there is another form control present, then control passes to block 203 to get the next control in the form. If there is not another form control present, then the process ends, at block 211.

Automatic Query Generation

FIG. 3 is a flow diagram that illustrates a process for automatically filling a Web page form text input control using unsupervised content discovery, according to an embodiment of the invention. In one embodiment, the process illustrated in FIG. 3 is implemented for automated performance by a conventional computing system, such as computer system 500 of FIG. 5. Further, in one embodiment, the process illustrated in FIG. 3 is implemented for automated performance within a software system architecture, such as that illustrated in FIG. 1.

Generally, with automatic query generation, Web page forms are filled in with relevant query terms obtained from the page that contains the form. The Web page is analyzed and the routine described hereafter makes use of the frequency and significance of the terms in the page to determine the content of the page. This is because Web pages that contain a search form usually display information about the content of the Web database that can be searched via the form. Hence, the frequency of word occurrence in a page furnishes a useful measurement of word significance. This fact is used to generate query terms that are most significant and popular at the web site, to form relevant query terms. Thus, the n most popular or most relevant terms in the page can be added to a set of keywords for use in filing the text input controls in the form. Further, other controls, such as list boxes and radio buttons, present a small set of fixed enumerations which can be randomly combined with the determined set of keywords to submit queries on the form.

Automated Query Keyword Determination

At block 301, a form is retrieved that is to be submitted using automatic content discovery and query generation. For example, a Web page form with a control classified (at block 208 of FIG. 2) for automatic content discovery filling is retrieved from crawler-based storage.

At block 302, a set of keywords is determined for use in querying Web content that is accessible via submission of the Web page form that includes a fillable control, such as a text input type of control. This step may be performed by, e.g., term processor 106 (FIG. 1), by analyzing and processing information about the content of the Web page and other Web pages associated with the same Web site with which the Web page is associated, e.g., from crawler system 114 (FIG. 1). The set of keywords is at times referred to herein as a set of interesting keywords.

In one embodiment, the most significant terms are extracted from a page to serve as the set of keywords, as follows. The frequency of occurrence ƒof various words in given page of text, and their rank order r (i.e., the order of their frequency of occurrence relative to other words in the text) are determined. A plot relating ƒand r typically yields a hyperbolic curve that demonstrates Zipf's Law, which essentially states that the product of the frequency of use of words and the rank order is approximately constant. In other words, the frequency of a word is inversely proportional to its statistical rank.

Hence, it has been previously suggested that the words exceeding in frequency an upper threshold are considered to be common and those words below a lower threshold are considered rare and, therefore, not contributing significantly to the content of the article, e.g., the Web page. Consistent with this notion, the resolving power of significant words, by which is meant the ability of words to discriminate content, was found to have reached a peak at a rank order position half way between the two thresholds and, from the peak, fell off in either direction reducing to almost zero at the threshold levels.

Hence, in one embodiment, the n terms surrounding the peak (i.e., the mean ranking) are used to get n most significant terms on the page and these terms can be used as query terms for automatically filling text input controls in the Web page forms. That is, the n/2 terms on each side of the mean ranked term are determined to be a set of keywords for automatic text input control filling for the page form, and for other page forms associated with the same Web site.

In one embodiment, the n terms are added to knowledge base 108 (FIG. 1) in association with the Web site currently being crawled (i.e., the site of which the given page is part). In one embodiment, the n terms are used to retrieve Web content that is accessible via submission of the form, by automatically filling one or more text input controls in the form with one or more keywords from the set of keywords (e.g., the n most significant terms on the page), and submitting the form with the filled control(s) to a server to retrieve the corresponding content.

Further, generation of the set of keywords for a given Web page may (a) begin with analysis of the corresponding home page for the Web site with which the given page is associated, and (b) continue by adding to the set of keywords based on the content of Web pages, from the same site, that are crawled leading up to the given page. Hence, the deeper into the Web site a given Web page is, the larger and more exhaustive the corresponding set of keywords is, because the set is based on better knowledge of the site.

Automated Query Keyword Expansion

In one embodiment an “expanded” set of keywords is determined for use in querying Web content that is accessible via submission of the form. The expanded set of keywords is determined based on automated analysis of the content of one or more Web pages from one or more Web sites other than the site currently being crawled. Generally, the expanded set of keywords is determined based on the correlation between terms found in one or more other Web pages or sites that include a term that is present in the Web page being processed.

For example, at block 306, interesting keywords are retrieved from the knowledge base 108 (FIG. 1) for the site currently being crawled. For example, m keywords are retrieved, where the m keywords for a Web site comprises the n significant keywords from each of the crawled Web pages associated with the Web site. Alternatively, the interesting keywords retrieved for use with a particular Web page may be a subset of the m keywords for the associated Web site. At block 308, the m interesting keywords are expanded into (m+e) keywords, where e refers to keywords obtained by expanding the m keywords as follows.

A document or page representation is maintained locally by the crawler or associated extraction system in the form of a document vector matrix in which, for example, the rows represent pages and the columns represent terms in the document. Each vector is defined by a combination of weights corresponding to each page that contains the term. These pages used for term correlation may or may not be from the same Web site or host. In one embodiment, the similarity process is applied to terms from Web pages associated with different Web sites. Thus, term knowledge base 108 (FIG. 1) stores information about the frequency of occurrence of terms in various crawled Web pages, partitioned by Web host (i.e., by Web site, or domain), which is used to correlate related terms across Web sites. Determination of the expanded set of keywords may be performed, e.g., by term processor 106 (FIG. 1), by analyzing and processing information about the content of other Web pages, e.g., information from result page processor 112 (FIG. 1) and/or from crawler system 114 (FIG. 1).

In one embodiment, the weights assigned to a particular term are simply assigned as the frequency of occurrence of the term in each page. For example, if a particular term occurs eight times in a particular page, then the weight assigned to that term for that page would be eight. Throughout the techniques described herein, variations of a word may be considered as the same term. For example, “automobile”, “automobiles”, and “auto” may be weighted together as the same term.

In one embodiment, the weights assigned to a particular term present in a particular page are assigned based on a concept referred to as TF-IDF (term frequency-inverse document frequency). Use of TF-IDF is a way of weighting the relevance of a term to a document. The TF-IDF ranking takes two ideas into account for the weighting. The term frequency in the given document (term frequency=TF) and the inverse document frequency of the term in the whole database of terms (inverse document frequency=IDF). The term frequency in the given document shows how important the term is in this particular document. The document frequency of the term (the percentage of the documents which contain this term) shows how generally important the term is across documents because it is the log of the number of all documents divided by the number of documents containing the term. A high weight in a TF-IDF ranking scheme is therefore reached by a high term frequency in the given document and a low document frequency of the term in the whole database.

By viewing a particular term to be vector in the n-dimensional space of n documents or pages, it is possible to expand the extracted significant terms to cover most of what are considered related terms. This is important because, for example, the term “automobile” may not find pages containing “engine” or “chassis”, which may in fact be pages describing automobiles. Thus, “interesting” terms for one Web site may be determined to be “related” terms for another Web site.

Cosine Measure of Similarity

In one embodiment, a cosine measure of similarity is used to expand the set of terms used to fill form text input controls. With the cosine measure of similarity, the cosine angle is calculated between pairs of term vectors. For example, each of the respective terms of the n terms for a particular page or site are paired with each of the terms found in other pages or sites that contain the respective term (e.g., from term knowledge base 108 of FIG. 1). The terms corresponding to the vectors corresponding to low values of cosine angle are used to expand the first set of keywords with m terms that are substantively related to each other. Such terms are likely effective in more exhaustively crawling the hidden Web associated with the page being crawled. That is, the expanded terms increase the “coverage” of the hidden Web crawl. For a non-limiting example, a 10° cosine angle between term vectors has been found to be effective in determining related terms across Web sites. In one embodiment, the similarity process is applied across Web sites, rather than across Web pages from the same Web site.

In one embodiment, at block 310, the (m+e) terms are used to retrieve Web content that is accessible via submission of the form. Such content is retrieved by automatically filling one or more form controls (e.g., text input controls) with one or more keywords from the set and expanded sets of keywords (e.g., the m most significant terms for the Web site with which the page is associated, and the corresponding related e terms from other Web sites), and submitting the form with the filled control(s) to a server to retrieve the corresponding content.

Submission of Web page forms, with text input controls automatically filled based on the content of the page and based on similar page content, provides a mechanism to systematically and intelligently access the data behind the forms, i.e., to crawl the hidden Web. Thus, in one embodiment, information about the Web content that is retrieved via this mechanism is indexed in association with the corresponding keyword(s) used to retrieve the content. Consequently, links to such content can be returned in response to user searches that correspond to such content, thereby making “visible” the “invisible Web.” That is, each resulting page is parsed, links and textual information are extracted, and the page may be returned to the crawler system 114 (FIG. 1) for further processing.

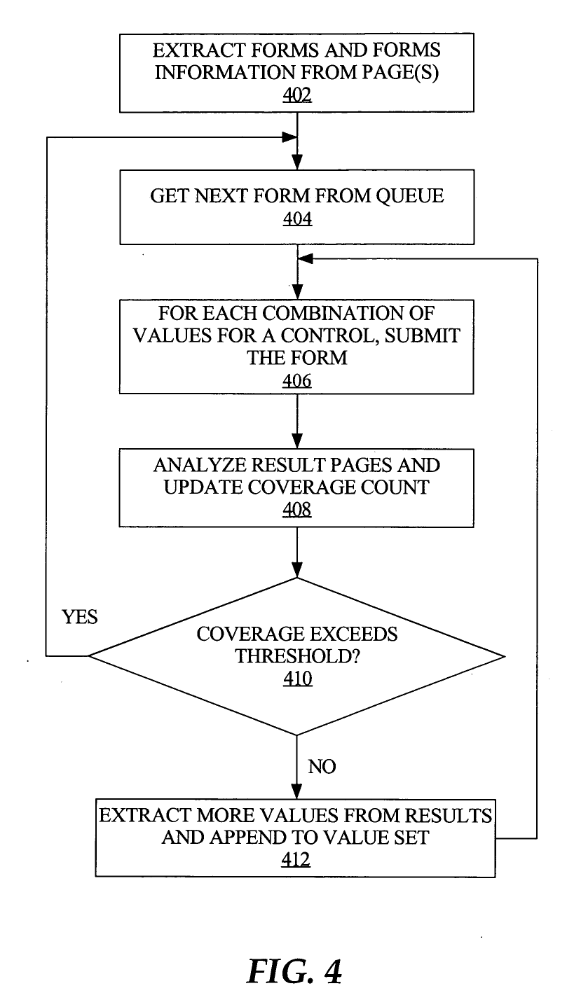

At decision block 312, it is determined whether desired coverage has been achieved. In one embodiment, determination of whether or not desired coverage has been achieved is performed according to the process illustrated in and described in reference to FIG. 4. If desired coverage is achieved, then form submission for this form is completed, at block 314. In one embodiment, if desired coverage is not yet achieved, then the form is re-queried with additional information extracted from the result pages, until a desired level of coverage is reached. In other words, information from pages retrieved via submission of the form can be used to recursively iterate the process illustrated in FIG. 3 to further crawl the site. For example, result page processor 112 provides, to term knowledge base 108, terms extracted from result pages. Thus, term processor 106 can run these new terms through similarity processing to further expand the keyword value set so that form submitter 110 can use newly discovered related terms for additional filling of form controls and submission of filled forms. For example, at block 316, result pages from submission of the form are placed in a page queue for processing. At block 318, the next page in the page queue is fetched and control passes back to block 302 to determine interesting keywords from the next page.

Monitor Coverage of Host Being Crawled

During a crawl of a Web site, information is maintained about the links and pages that have already been retrieved, for example, by maintaining a hashed value of the links. This is useful in detecting and eliminating duplicate pages, which is effective in avoiding unnecessary processing and, therefore, saving processing time. Further, this information about pages that have already been retrieved is useful in determining the coverage of the crawl reached at any point in the process.

In one embodiment, while crawling the hidden Web content via multiple submissions of a page form and resultant page retrievals, an average is maintained of the number of links from the retrieved pages that have been previously encountered. Hence, in response to the average reaching a particular predefined threshold value, the crawl of that particular site is terminated, i.e., submission of the form to retrieve additional content is terminated.

FIG. 4 is a flow diagram that illustrates a process for crawling a site associated with content that is accessible via submission of a page form, according to an embodiment of the invention. In one embodiment, the process illustrated in FIG. 4 is implemented for automated performance by a conventional computing system, such as computer system 500 of FIG. 5. Further, in one embodiment, the process illustrated in FIG. 4 is implemented for automated performance within a software system architecture, such as that illustrated in FIG. 1.

At block 402, forms and form information are extracted. For example, during a crawl of a Web site, form extractor 104 (FIG. 1) extracts HTML forms from pages encountered during the crawl. Such forms can be placed in a form queue for further processing, such as for automatic query generation/text box filling according to techniques described herein.

At block 404, the next form in the queue is retrieved for processing and the form is submitted for each combination of values for the included form controls, at block 406. For example, combinations of values for text input controls and possibly other controls (e.g., selection boxes, radio buttons, checkboxes, and the like), whether the values are from a user configuration file, are default page values, or are from automatic query generation as described herein, are systematically submitted to the host server to retrieve the corresponding content.

At block 408, the corresponding result pages are analyzed and the coverage count is updated. That is, more and more terms are extracted from the resulting pages, such as by result page processor 112 (FIG. 1) and/or crawler system 114 (FIG. 1), and are added to the set(s) of keywords in term knowledge bas 108 for use in filling form controls by form submitter 110 (FIG. 1). In one embodiment, a running average is maintained for the number of links, on the result pages, which have already been encountered during this or a previous crawl. When the average is consistently high or above a predetermined threshold value, this is considered an indication that the site coverage has reached a particular level, and the querying is stopped on that particular form.

The coverage measure is maintained on a per host (i.e., per Web site) basis, i.e., automatic form filling stops when the coverage for that web site reaches the threshold coverage. Thus, at decision block 410, it is determined whether or not the coverage exceeds the predetermined threshold value. If the coverage exceeds the predetermined threshold value, then control can return to block 404 to get the next form in the queue for processing. If the coverage does not exceed the predetermined threshold value, then at block 412 more values are extracted from the result pages and these values are added to the value set, e.g., the set of keywords used for filling the form text input control(s). Control then returns to block 406 for submission of new combinations of values for the form controls.

Experimentation with the techniques described herein, in the context of crawling a particular Web domain, has shown that the query engine 102 was able to retrieve approximately twenty times the number of Web pages compared to a traditional crawl, i.e., a crawl of the PIW only.

Hardware Overview

FIG. 5 is a block diagram that illustrates a computer system 500 upon which an embodiment of the invention may be implemented. Computer system 500 includes a bus 502 or other communication mechanism for communicating information, and a processor 504 coupled with bus 502 for processing information. Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

The invention is related to the use of computer system 500 for implementing the techniques described herein. According to one embodiment of the invention, those techniques are performed by computer system 500 in response to processor 504 executing one or more sequences of one or more instructions contained in main memory 506. Such instructions may be read into main memory 506 from another machine-readable medium, such as storage device 510. Execution of the sequences of instructions contained in main memory 506 causes processor 504 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 500, various machine-readable media are involved, for example, in providing instructions to processor 504 for execution. Such a medium may take many forms, including but not limited to, non-volatile media, volatile media, and transmission media. Non-volatile media includes, for example, optical or magnetic disks, such as storage device 510. Volatile media includes dynamic memory, such as main memory 506. Transmission media includes coaxial cables, copper wire and fiber optics, including the wires that comprise bus 502. Transmission media can also take the form of acoustic or light waves, such as those generated during radio-wave and infra-red data communications.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 504 for execution. For example, the instructions may initially be carried on a magnetic disk of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet”528. Local network 522 and Internet 528 both use electrical, electromagnetic or optical signals that carry digital data streams. The signals through the various networks and the signals on network link 520 and through communication interface 518, which carry the digital data to and from computer system 500, are exemplary forms of carrier waves transporting the information.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution. In this manner, computer system 500 may obtain application code in the form of a carrier wave.

Extensions And Alternatives

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

Alternative embodiments of the invention are described throughout the foregoing specification, and in locations that best facilitate understanding the context of the embodiments. Furthermore, the invention has been described with reference to specific embodiments thereof. It will, however, be evident that various modifications and changes may be made thereto without departing from the broader spirit and scope of the invention.

In addition, in this description certain process steps are set forth in a particular order, and alphabetic and alphanumeric labels may be used to identify certain steps. Unless specifically stated in the description, embodiments of the invention are not necessarily limited to any particular order of carrying out such steps. In particular, the labels are used merely for convenient identification of steps, and are not intended to specify or require a particular order of carrying out such steps.

What is claimed is:

1. A computer-implemented method comprising:
generating a set of keywords based on automated analysis of the content of one or more Web pages associated with a Web site;
for a Web page associated with the Web site,
automatically filling, with at least one keyword from the set of keywords, a form control within a form contained in the Web page; and
submitting, to a host server, the form with the filled form control.

2. The method of claim 1, comprising:
for the Web page, repeatedly
automatically filling the form control within the form contained in the Web page with different one or more keywords from the set of keywords; and
submitting, to a host server, the form with the filled form control.

3. The method of claim 2, comprising:
maintaining an average of the number of links, from Web content retrieved via submission of the form, that have already been encountered while crawling the Web site; and
in response to the average reaching a particular threshold value, terminating submitting the form to retrieve Web content.

4. The method of claim 1, wherein the form control is a text input type of form control.

5. The method of claim 1, wherein the set of keywords is generated based at least in part on automated analysis of the content of the Web page.

6. The method of claim 1, wherein the set of keywords is generated based on the number of times respective terms occur in respective Web pages of the Web site.

7. The method of claim 1, wherein generating the set of keywords comprises, for each of the one or more Web pages associated with the Web site:
identifying all unique terms in the Web page;
determining the number of times each unique term occurs in the Web page;
ranking each unique term based on the number of times each unique term occurs in the Web page to generate ranked unique terms;
identifying the mean ranked term from the ranked unique terms;
identifying n particular keywords surrounding the mean ranked term; and
adding the n particular keywords to the set of keywords.

8. The method of claim 7, wherein identifying the n particular keywords comprises identifying n/2 keywords on each side of the mean ranked term.

9. The method of claim 1, comprising:
indexing, in association with the at least one keyword, information about Web content retrieved via submission of the form.

10. The method of claim 1, wherein the Web site is a first Web site, the method comprising:
generating an expanded set of keywords based on automated analysis of the content of one or more Web pages associated with a second Web site, other than the first Web site, that include a keyword from the set of keywords; and
for the Web page,
automatically filling, with at least one keyword from the expanded set of keywords, the form control within the form contained in the Web page; and
submitting, to the host server, the form with the filled form control.

11. The method of claim 10, wherein generating the expanded set of keywords comprises:
(a) maintaining weighting factors for corresponding terms in the Web pages associated with the first Web site and the Web pages associated with the second Web site, wherein each weighting factor is based on the number of occurrences of the corresponding term in the corresponding Web page in which the corresponding term occurs;
(b) representing terms in the Web pages as corresponding vectors in n-dimensional space, wherein n is the number of Web pages associated with the first Web site and the Web pages associated with the second Web site, and wherein each corresponding vector is defined by the corresponding weighting factors for the corresponding term;
(c) calculating cosine angles between pairs of the vectors, wherein each pair of vectors comprises at least one vector corresponding to a term from a Web page associated with the second Web site; and
if a cosine angle between a pair of vectors is calculated to be less than a particular threshold value, then
(d) identifying the term, that is from the Web page associated with the second Web site, that corresponds to the at least one vector, and
(e) including in the expanded set of keywords the term from the Web page associated with the second Web site.

12. The method of claim 11, comprising:
based at least on the Web content retrieved via submission of the form, recursively iterating (a) through (e).

13. The method of claim 10, comprising:
indexing, in association with the at least one keyword from the expanded set of keywords, information about Web content retrieved via submission of the form.

14. A machine-readable medium carrying one or more sequences of instructions which, when executed by one or more processors, causes the one or more processors to perform the method recited in claim 1.

15. A machine-readable medium carrying one or more sequences of instructions which, when executed by one or more processors, causes the one or more processors to perform the method recited in claim 2.

16. A machine-readable medium carrying one or more sequences of instructions which, when executed by one or more processors, causes the one or more processors to perform the method recited in claim 3.

17. A machine-readable medium carrying one or more sequences of instructions which, when executed by one or more processors, causes the one or more processors to perform the method recited in claim 4.

18. A machine-readable medium carrying one or more sequences of instructions which, when executed by one or more processors, causes the one or more processors to perform the method recited in claim 5.

19. A machine-readable medium carrying one or more sequences of instructions which, when executed by one or more processors, causes the one or more processors to perform the method recited in claim 6.

20. A machine-readable medium carrying one or more sequences of instructions which, when executed by one or more processors, causes the one or more processors to perform the method recited in claim 7.

21. A machine-readable medium carrying one or more sequences of instructions which, when executed by one or more processors, causes the one or more processors to perform the method recited in claim 8.

22. A machine-readable medium carrying one or more sequences of instructions which, when executed by one or more processors, causes the one or more processors to perform the method recited in claim 9.

23. A machine-readable medium carrying one or more sequences of instructions which, when executed by one or more processors, causes the one or more processors to perform the method recited in claim 10.

24. A machine-readable medium carrying one or more sequences of instructions which, when executed by one or more processors, causes the one or more processors to perform the method recited in claim 11.

25. A machine-readable medium carrying one or more sequences of instructions which, when executed by one or more processors, causes the one or more processors to perform the method recited in claim 12.

26. A machine-readable medium carrying one or more sequences of instructions which, when executed by one or more processors, causes the one or more processors to perform the method recited in claim 13.
